(19) United States
(12) Patent Application Publication
(10) Pub. No.: US 2014/0071074 A1
(43) Pub. Date: Mar. 13, 2014

(54) ADAPTIVE SCROLLING OF IMAGE DATA ON DISPLAY

(71) Applicant: Calgary Scientific Inc., Calgary (CA)

(72) Inventors: Michael Robert Cousins, Calgary (CA); Kenneth Todd Reed, Calgary (CA)

(73) Assignee: Calgary Scientific Inc., Calgary (CA)

(21) Appl. No.: 14/022,731

(22) Filed: Sep. 10, 2013

Related U.S. Application Data
(60) Provisional application No. 61/699,234, filed on Sep. 10, 2012.

(51) Int. Cl. G06F 3/01; G06F 3/041; G09G 5/34

(52) U.S. Cl. CPC G06F 3/017; G09G 5/34; G06F 3/0412
USPC 345/173

(57) ABSTRACT

Systems and methods that enable a client device to control scrolling of image data such as slices of MR or CT images using a scrolling gesture. The gesture may be received from a human interface device, and may be mouse moments, touchpad inputs, game controller movements, trackball movements or a movements on a touch-sensitive display. When a scrolling gesture is received at the client device, a velocity and distance of the swipe may be measured. Based on a relationship of gesture velocity to slice scroll velocity, both fine and course scrolling may be provided through the gesture. Control of document scrolling on the display of a client device is also provided.

### CROSS-REFERENCE TO RELATED APPLICATION

This application claims priority to U.S. Provisional Patent Application No. 61/699,234, filed Sep. 10, 2012, entitled “ADAPTIVE SCROLLING OF IMAGE DATA ON A TOUCH-SENSITIVE DISPLAY,” which is incorporated herein by reference in its entirety.

### BACKGROUND

In image data viewing, where a sequence or set of images is presented for display, a scrolling gesture such as a swipe or a pan often represents a user's intent to scroll through the sequence or set of images. Often, the scrolling gesture distance per image is correlated to dataset size. However, this may result in an inconsistent user experience, especially when the set of images in the sequence is small, as a distance that must be traversed to scroll through each image is relatively large. Further, for large sets of images, it is difficult to fine scroll though only a few images at a time, as the relative scrolling gesture distance per image is very small. Therefore, fine scrolling is often provided. For example, in image gesture scrolling on a touch-sensitive interface such as on a mobile device, fine scrolling may be provided by a second gesture, such as a tapping function or by fine scrolling buttons, rather than the image scrolling gesture.

### SUMMARY

Disclosed herein are systems and methods for adaptive scrolling. In particular methods and systems are provided for controlling the scrolling of the images through image gestures such as a swipe or a pan on a touch sensitive interface, such as a touch sensitive display. Aspects of the present disclosure may also be applied to scrolling gestures from a human interface device (HID), such as mouse moments, touchpad inputs, game controller movements, and trackball movements. In an implementation, a number of images that are scrolled on a device may be based on (i) a scrolling gesture distance and (ii) a velocity of the scrolling gesture and (iii) screen size. In other implementations, the number of images scrolled may be dependent on (i) a scrolling gesture distance, (ii) a velocity of the scrolling gesture, and (iii) a dataset size, and optionally (iv) screen size.

In accordance with some aspects, there is provided a method of adaptive scrolling of images within a set of images where the images are displayed on a touch-sensitive display of a computing device. The method may include defining a relationship of image gesture velocity to an image scroll velocity; displaying an image from within the set of images on the touch-sensitive display; receiving a user-initiated gesture on the touch-sensitive display; determining a velocity of the user-initiated gesture; and correlating the velocity of the user-initiated gesture to the image scroll velocity using the relationship to scroll the images on the touch-sensitive display.

In accordance with other aspects, there is provided a computing device that includes a memory that stores one or more modules, an interface adapted to receive a user input thereon, and a processor that executes the one or more modules. The modules may be executed to define a relationship of image gesture velocity to an image scroll velocity; display an image from within the set of images; receive a user-initiated gesture; determine a velocity of the user-initiated gesture; and correlate the velocity of the user-initiated gesture to the image scroll velocity using the relationship to scroll the images on the display.

In accordance with yet other aspects, there is provided a method of adaptive scrolling a document displayed on a display of a computing device. The method may include defining a relationship of image gesture velocity to a document scroll velocity, the relationship being based on one of a screen size of the display and a document size; displaying the document on the display; receiving a user-initiated gesture; determining a velocity of the user-initiated gesture; and correlating the velocity of the user-initiated gesture to the document scroll velocity using the relationship to scroll the images on the display.

Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF THE DRAWINGS

The components in the drawings are not necessarily to scale relative to each other. Like reference numerals designate corresponding parts throughout the several views.

FIG. 1 illustrates an exemplary computing device;

FIG. 2 illustrates a first relationship of scrolling gesture velocity to image scroll velocity;

FIG. 3 illustrates an operational flow 300 of scrolling in accordance with an application of the first relationship to a scrolling gesture made on a touch-screen display;

FIG. 4 illustrates a second relationship of scrolling gesture velocity to image scroll velocity;

FIG. 5 illustrates an operational flow 500 of scrolling in accordance with an application of the second relationship to a scrolling gesture made on a touch-screen display;

FIG. 6 is a simplified block diagram illustrating a system for providing remote access to an application at a remote device via a computer network; and

FIG. 7 is a simplified block diagram illustrating an operation of the remote access program in cooperation with a state model.

### DETAILED DESCRIPTION

Unless defined otherwise, all technical and scientific terms used herein have the same meaning as commonly understood by one of ordinary skill in the art. Methods and materials similar or equivalent to those described herein can be used in the practice or testing of the present disclosure. While implementations will be described for remotely accessing applications, it will become evident to those skilled in the art that the implementations are not limited thereto, but are applicable for remotely accessing any type of data or service via a remote device.

Overview

A computing device may display image data that may be arranged as a set of images and displayed to a user such that at any given time, one image from the set of images is displayed. An example may be a slice from a MR or CT dataset or a slide of a POWERPOINT deck. Provided herein are methods for controlling scrolling through the images using gestures such as a pan or a swipe (herein a “scrolling gesture”). In an implementation, a number of images that are scrolled on a device may be based on (i) a distance of the scrolling gesture and (ii) a velocity of the scrolling gesture and (iii) screen size. In other implementations, the number of images scrolled may be dependent on (i) a distance of the scrolling gesture, (ii) a velocity of the scrolling gesture, and (iii) a dataset size, and optionally (iv) screen size. As such, a consistent user interface may be provided whereby the same scrolling gesture may be used to rapidly scroll through a large dataset (e.g. >1000 images) and to finely control the scrolling of the images, without a need for a secondary control for fine scrolling, as well as to provide an intuitive response when the dataset size is small (e.g., <20).

As an application of the above, the computing device may display MR or CT dataset that are comprised of multiple slices. The scrolling of slices of the MR or CT images may be performed using the scrolling gesture. Thus, based on the above, a scrolling gesture may be used to rapidly scroll through a large dataset (e.g. >1000 slices) and to finely control the scrolling of the slices when the dataset size is small (e.g., <20).

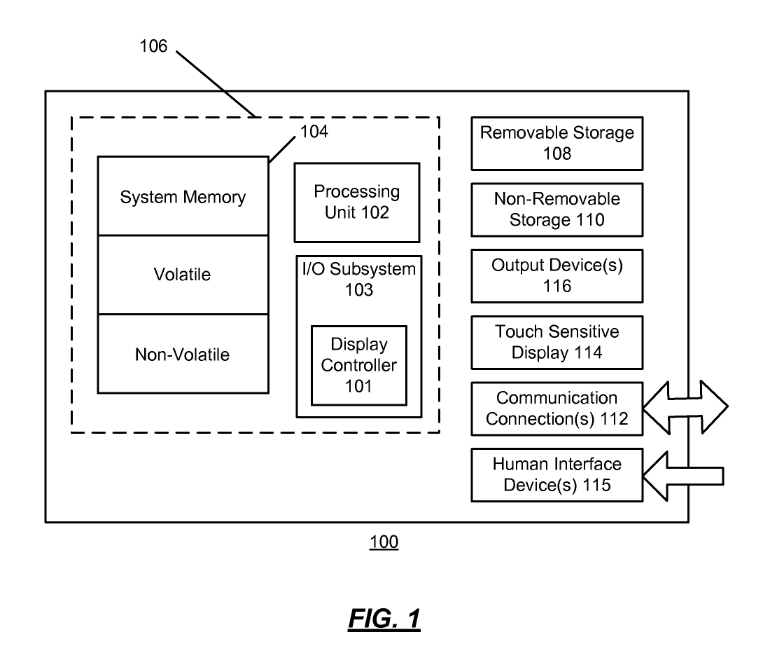

FIG. 1 shows an exemplary computing environment in which example embodiments and aspects may be implemented. In some instances, the exemplary computing device may be computing device having a touch-sensitive display, such as IPAD, an IPHONE, an ANDROID-based device or any other device having a touch-sensitive display. The computing system environment is only one example of a suitable computing environment and is not intended to suggest any limitation as to the scope of use or functionality.

With reference to FIG. 1, an exemplary system for implementing aspects described herein includes a computing device, such as computing device 100. In its most basic configuration, computing device 100 typically includes at least one processing unit 102 and memory 104. Depending on the exact configuration and type of computing device, memory 104 may be volatile (such as random access memory (RAM)), non-volatile (such as read-only memory (ROM), flash memory, etc.), or some combination of the two. This above configuration is illustrated in FIG. 1 within a dashed line 106.

An I/O subsystem 103 couples input/output peripherals on the device 100, such as a touch-sensitive display 114 and other output devices 116. While the system will be further described with the touch-sensitive display 114, other human interface devices 115 may be employed for input, such as a mouse, a trackball, a keyboard, a joystick, a remote control, a fingerprint sensor, and a medical instrumentation. The I/O subsystem 103 may include a display controller 105. The touch-sensitive display 114 provides an input interface and an output interface between the device 100 and a user. The display controller 105 receives and/or sends electrical signals from/to the touch-sensitive display 114. The touch-sensitive display 114 displays visual output to the user. The visual output may include graphics, imagery, text, icons, video, and any combination thereof. In some embodiments, some or all of the visual output may correspond to user interface objects.

The touch-sensitive display 114 has a touch-sensitive surface, sensor or set of sensors that accepts input from the user based on haptic and/or tactile contact. The touch-sensitive display 114 and the display controller 105 (along with any associated modules and/or sets of instructions in memory 104) detect contact, movement or breaking of the contact on the touch-sensitive display 114. For example, a point of contact on the touch-sensitive display 114 may correspond to contact of a finger of the user with the touch-sensitive display 114.

The touch-sensitive display 114 may use liquid crystal display (LCD) technology or light emitting polymer display (LPD) technology, although other display technologies may be used. The touch-sensitive display 114 and the display controller 105 may detect contact, movement or breaking thereof using technologies, including but not limited to capacitive, resistive, infrared, and surface acoustic wave technologies, as well as other proximity sensor arrays or other elements for determining one or more points of contact with the touch-sensitive display 114.

Computing device 100 may have additional features/functionality. For example, computing device 100 may include additional storage (removable and/or non-removable) including, but not limited to, magnetic or optical disks or tape. Such additional storage is illustrated in FIG. 1 by removable storage 108 and non-removable storage 110.

Computing device 100 typically includes a variety of computer readable media. Computer readable media can be any available media that can be accessed by device 100 and includes both volatile and non-volatile media, removable and non-removable media.

Computer storage media include volatile and non-volatile, and removable and non-removable media implemented in any method or technology for storage of information such as computer readable instructions, data structures, program modules or other data. Memory 104, removable storage 108, and non-removable storage 110 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 100. Any such computer storage media may be part of computing device 100.

Computing device 100 may contain communications connection(s) 112 that allow the device to communicate with other devices. Computing device 100 may also include a touch-sensitive display 114. Output device(s) 116 such as a display, speakers, printer, etc. may also be included. All these devices are well known in the art and need not be discussed at length here.

Scrolling Logic and Methods

As an example, a type of image data organized into a set of images is MR or CT images. As known by those of skill in the art, MR or CT images are presented as a series of slices that are maintained in a data set associated with, e.g., a patient. The data sets may range in size from tens of slices to thousands of slices. Typically, about 90% of the user interaction with such image data involves scrolling through the images. In accordance with the present disclosure, scrolling logic is provided that enables both fine and coarse scrolling through the slices using a scrolling gesture, such as a pan or swipe, based on predetermined factors that may be used to determine how rapidly slices are scrolled during the user scrolling gesture. A pan gesture is a continuous gesture that moves the dataset in both directions. A swipe gesture is a short, discrete event in one direction. These factors include, but are not limited to, a scrolling gesture distance, a velocity of the scrolling gesture, a screen size multiplier, and dataset size. Any combinations or subsets of the factors may be used. In accordance with the above, the same scrolling gesture may be used for both fine and coarse growing. Thus, the use of tap gestures and/or scroll buttons for fine scrolling is eliminated, while a consistent user experience is also provided between large and small dataset sizes. Aspects of the present disclosure may also be applied to mouse moments, touchpad inputs, game controller movements, and trackball movements.

Below is a description of example scroll response functions that may be implemented in the computing device 100 of the present disclosure. The scroll response functions are being provided for exemplary purposes only, and should not be considered to limit the present disclosure, as there are many other functions that could be used to achieve the result described below.

A scroll response function may be defined as a function that maps physical panning velocity to scroll distance. Scroll distance is the number of “document units” to scroll in response to a pan gesture. Document units is application specific, and could be, e.g., a number of lines in a text document, the number of 2D images in a 3D image dataset, etc.

In general, the scroll response function ƒ is a function of distance Δd and time Δt:

D=ƒ(Δd;Δt)

where Δd and Δt are the distance and time measured by a device for a panning gesture. During a single pan gesture, the device continuously yields Δd and Δt measurements.

In some implementations, Δd is a signed value, with the sign indicating the direction of panning—positive distances typically indicating downward motion, and negative distances indicating upward motion. This could easily be generalized to two-dimensions, in which case Δd would be replaced by a vector p=(Δx; Δy).

In accordance with the present disclosure, two scroll response functions are demonstrated: one parameterized on screen size, and another parameterized by the document size.

Below is a description of adapting to the scroll response to a screen size. For example, let:
Δd be the distance in centimeters,
Δt be the time in seconds,

$$S be a screen multiplier where S • \frac{64}{screen size in centimeters}$$

Lₘᵢₙ□5 is a fine scrolling limit,
Lₘₐₓ□100 is a course scrolling limit,
m□0.4 is the slope of scroll response function,
b=1−Lₘᵢₙ is the offset of the scroll response function,
Then the scroll response function is:

D=V(v′,Δt)Δd′
where
Δd′=dS is the “converted” distance,

$${v}^{′} = \frac{Δ {d}^{′}}{Δ t} is the “ converted ” velocity ,$$

V (v, t) is the velocity multiplier:

$$V ( v , t ) = \{ \begin{matrix}1 & if \vert v \vert < {L}_{min} \\ mv + b & if \vert v \vert < {L}_{max} \\ {mL}_{max} + b & if \vert v \vert \geq {L}_{max}\end{matrix}$$

Below is a description of adapting to the scroll response to a document size.
Let:
Δd be the distance in points.
Δt be the time in seconds.

$$v = \frac{Δ {d}^{′}}{Δ t} ( i . e . , the scroll velocity ) ,$$

S be the document size,
be a unit-less sensitivity coefficient that influences the slope of the scroll response function,
L is a fine scroll limit (e.g., L=30 points per second), and
c is a scaling factor (with units document units per distance) used to control fine scrolling.

Then the scroll response function is:

$$D = \{ \begin{matrix}c Δ t & if \vert v \vert < {L}_{min} \\ sgn ( v ) \frac{S}{2} [ tanh ( s \vert v \vert - 2 + 1 ] Δ & otherwise\end{matrix}$$

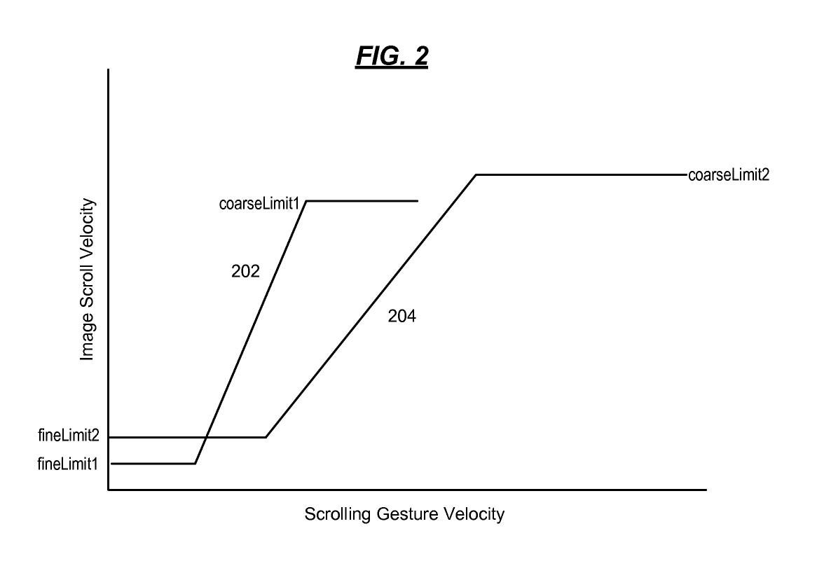

FIGS. 2-5 provide additional details of the scroll response functions of the present disclosure. FIG. 2 represents an example scrolling gesture velocity to slice scroll velocity relationship. Thus, the image scroll velocity may be determined based on a relationship defined by (i) a scrolling gesture distance and (ii) a velocity of the scrolling gesture. Optionally, screen size may be taken into account. The scrolling gesture distance and a velocity of the scrolling gesture may be measured directly from the touch-sensitive display 114, as is known in the art. For example, the swipe distance calculated by the display controller 105 by determining a first point of contact of, e.g., a user's finger on the touch-sensitive display and tracking the contact until the user lifts his or her finger from the display surface. The swipe distance derived as a total number of pixels that make up a line from the point of initial contact to the point of last contact. The velocity of the swipe may be determined by measuring a time between two known points of contact on the touch-sensitive display. For example, a time may be measured between a predetermined number of pixels as the user's fingers traverses the touch-sensitive display, e.g., 20 (or other number) pixels of movement. The determined velocity value, thus will be described as a number of pixels per unit of time, e.g., pixels/second. The swipe velocity may be correlated to an image scroll velocity, as will be described below. The image scroll velocity may be described as a number of images per unit time, e.g., images/second. The image scroll velocity is used to determine a number of images as the user swipes the touch-sensitive display.

For pan gestures, the velocity and distance may be continuously measured by the touch-sensitive display. Further, direction may change during a pan gestures. As the velocity is measured, the pan velocity may be correlated to an image scroll velocity, as will be described below.

With reference to FIG. 2, there is illustrated example scrolling gesture velocity to image scroll velocity. As illustrated, relatively slower scrolling gesture velocities result in a slow slice scroll velocity that is maintained at a minimum over a range of slow scrolling gesture velocities. A minimum slice scroll velocity may be defined as a fineLimit. In other words, if a user slowly scrolling gestures his or her finger across the touch-sensitive display 114, slices associated with, e.g., patient image data will scroll slowly from one to the next at a fixed rate. Thus, relatively slow scrolling gesture velocities will result in fine control of the images being displayed on the touch-sensitive display 114. For example, the fineLimit may be 10-25 slices per inch scrolling gestured. As scrolling gesture velocity increases, the slice scroll velocity increases linearly until a maximum slice scroll velocity is reached, which may be defined as a coarseLimit. For example, the coarseLimit may be 75-100 slices per inch traversed. As illustrated, scroll velocities beyond a configurable amount result in the maximum scrolling gesture velocity of the coarseLimit. Thus, relatively fast scrolling gesture velocities will result in rapid scrolling of the slices associated with the patient image data. In the example of FIG. 2, the slope of the linearly increasing portion of the relationship maybe 0.5. Other slopes may be used to tune the scrolling gesture velocity to the slice scroll velocity.

For example, a multiplier may be used to account for screen size. In accordance with some implementations. Studies have shown that a larger a touch-sensitive display, the faster a user will swipe the display. As such, a screen size multiplier may be implemented to “tune” the scrolling. For example, a multiplier of 2-3 may be used for tablet devices, whereas a multiplier of 5-6 may be used for mobile handsets. Thus, a relationship may be established as follows:

fineLimit=0.5*screenMultiplier

coarseLimit=5*screenMultiplier,

where the fineLimit and the coarseLimit are the minimum and maximum slice scroll velocity, as described above. FIG. 2 illustrates the effect of the multiplier on the relationships for a handset (202) and a tablet (204), where it is shown that users may swipe faster on tablets than handhelds and the adjustments that can be made to the relationships to account for such variations in use. Although the fineLimit1 and fineLimit2, and coarseLimit1 and coarseLimit2 are shown as different values, they may be the same.

In accordance with the present disclosure, all of the above parameters may be user-configurable within the computing device 100. As such, a user may be provided full control over the behavior of the user interface with scrolling through a set of images on the computing device 100.

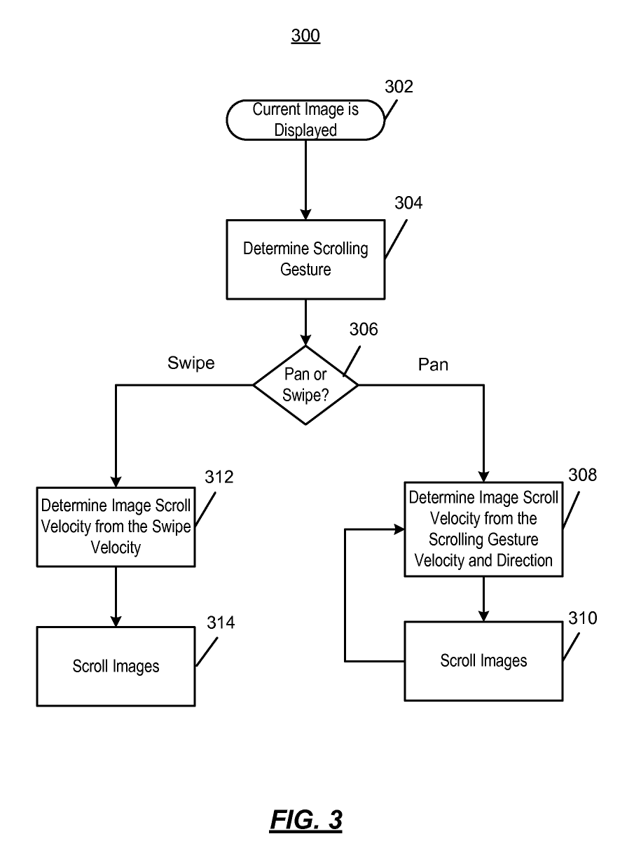

FIG. 3 illustrates an operational flow 300 of scrolling in accordance with a scrolling gesture made on a touch-screen display. The flow begins at 302, where an image of a set of images is displayed to the user. At 304, is determined that a scrolling gesture has been received by the touch-sensitive display. At 306 it is determined if the image scrolling gesture is a pan or a zoom. If at 306 the scrolling gesture is a pan, then at 308, an image scroll velocity is determined in accordance with the measured velocity of the pan gesture. Based on the parameters of the configuration of the computing device 100, the image gesture velocity to image scroll velocity may be defined as one of relationships 202 or 204. The relationship may be stored in the computing device 100 as a lookup table or as an algorithm that is applied to measured pan velocity over the distance and direction(s) of the pan. For example, for relatively slow pans, a slow scroll velocity may be determined, at or near the fineLimit. Similarly, for relatively fast pans, a faster scroll velocity is determined up to the maximum velocity (coarseLimit).

At 310, images are scrolled at the image scroll velocity determined at 308. For example, an initial scroll velocity determined at 308 is applied to determine a number of images to scroll as the user's finger traverses between two points. As the user continues to pan, the pan velocity may be measured between subsequent points to update the scroll velocity in accordance with the relationships of FIG. 2. The updating and image scrolling continues in a looping fashion between 308 and 310 until the user lifts his or her finger from the touch-sensitive display 114. In some implementations, the scrolling of images may slow from a last scroll velocity to a stop over a predetermined period of time after the user lifts his or her finger to provide a slowing down effect to the scrolling.

If at 306 it is determined that the scrolling gesture is a swipe, then at 312, a velocity of the swipe is measured by the client computing device and the image scroll velocity determined. The velocity may be determined by measuring swipe speed between an initial point and a terminal point of the swipe. At 314, images are scrolled at the image scroll velocity determined at 312. In some implementations, the scrolling of images may slow from the determined scroll velocity to a stop over a predetermined period of time after the user lifts his or her finger to provide a slowing down effect to the scrolling.

Thus, in accordance with the above, based on the velocity of a scrolling gesture received within the touch-sensitive display, the present disclosure provides for both fine and rapid scrolling of slices through—initiated gesture. Although the present disclosure has been described with reference to certain operational flows, other flows are possible. Also, while the present disclosure has been described with regard to patient image data, it is noted that scrolling of any type of image data may be enabled.

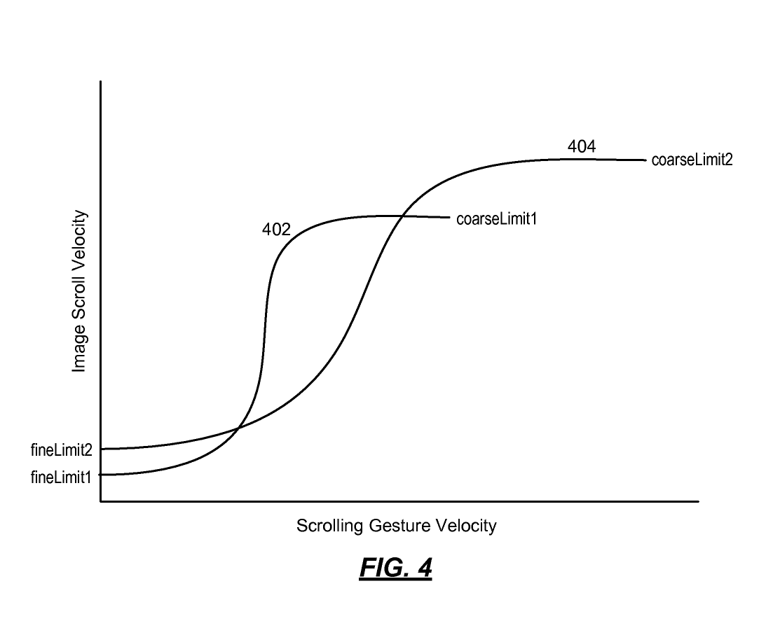

FIG. 4 represents another example of a scrolling gesture velocity to slice scroll velocity relationship. In the implementation of FIG. 4, the image scroll velocity may be dependent on (i) a scrolling gesture distance, (ii) a velocity of the scrolling gesture, and (iii) a dataset size, and optionally (iv) screen size.

The relationship of FIG. 4 is defined having a non-linear relationship of scrolling gesture velocity to image scroll velocity. Here again, relatively slower scrolling gesture velocities result in a relatively slower slice scroll velocity to provide for fine control. For example, the minimum fineLimit value may be 10-25 images per inch traversed when the scrolling gesture velocity is relatively slow. As scrolling gesture velocity increases, the slice scroll velocity will increase non-linearly until a maximum slice scroll velocity is reached. For example, the coarseLimit may be 100-500 slices per inch traversed. Thus, relatively fast scrolling gesture velocities will result in rapid scrolling. In accordance with the relationship of FIG. 4, (i.e., where dataset size is factored), a fast scrolling gesture across the touch-sensitive display 114 will result in scrolling through the entire data set. It is note that the relationship of FIG. 2 may also be used when dataset size is a factor.

In contrast, where scaling is not provided based on the data set size (FIG. 2), more than one scrolling gesture across the touch-sensitive display may be needed scroll to the entire data set. For example, three scrolling gestures may be needed to scroll through a data set.

In accordance with some implementations, and as noted above, screen size may be factored into the scrolling logic. Studies have shown that a larger a touch-sensitive display, the faster a user will swipe the display. As such, a screen size multiplier may be implemented to “tune” the scrolling. For example, a multiplier of 2-3 may be used for tablet devices, whereas a multiplier of 5-6 may be used for mobile handsets. Thus, a relationship may be established as follows:

fineLimit=0.5*screenMultiplier

coarseLimit=5*screenMultiplier,

where the fineLimit and the coarseLimit are the minimum and maximum slice scroll velocity, as described above. FIG. 4 illustrates the effect of the multiplier on the relationships for a handset (402) and a tablet (404), where it is shown that users may swipe faster on tablets than handhelds and the adjustments that can be made to the relationships to account for such variations in use. Although the fineLimit1 and fineLimit2, and coarseLimit1 and coarseLimit2 are shown as different values, they may be the same.

In accordance with the present disclosure, all of the above parameters may be user-configurable within the computing device 100. As such, a user may be provided full control over the behavior of the user interface with scrolling through a set of images on the computing device 100.

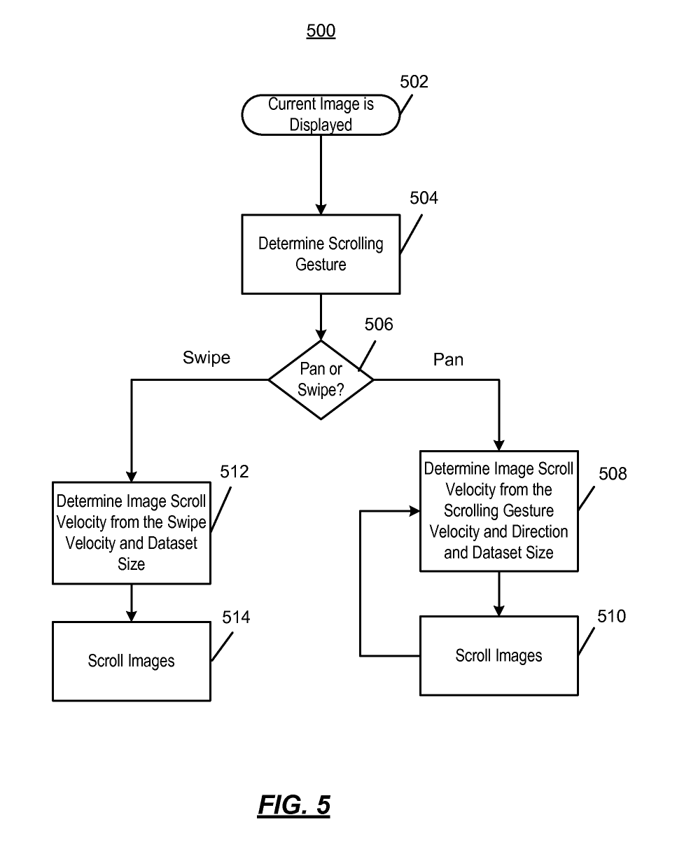

FIG. 5 illustrates an operational flow 500 of scrolling in accordance with a scrolling gesture made on a touch-screen display. The flow begins at 502, where a slice is currently being displayed to the user. At 504, it is determined that a scrolling gesture has been received by the touch-sensitive display. At 506, it is determined if the scrolling gesture is a pan or a zoom.

If at 506 the scrolling gesture is pan, then at 508, an image scroll velocity is determined in accordance with the measured velocity of the pan gesture. Based on the parameters of the configuration of the computing device 100, the image gesture velocity to image scroll velocity may be defined as one of relationships 402 or 404 that account for data set size. The relationship may be stored in the computing device 100 as a lookup table or as an algorithm that is applied to measured velocity over the distance of the pan. For example, for relatively slow pans, a slow scroll velocity may be determined, at or near the fineLimit. Similarly, for relatively fast pans, a faster scroll velocity is determined up to the maximum velocity (coarseLimit).

At 510, images are scrolled at the image scroll velocity determined at 508. For example, an initial scroll velocity determined at 508 is applied to determine a number of images to scroll as the user's finger traverses between two points. As the user continues to pan, the pan velocity may be measured between subsequent points to update the scroll velocity in accordance with the relationships of FIG. 4. The updating and image scrolling continues in a looping fashion between 508 and 510 until the user lifts his or her finger from the touch-sensitive display 114. In some implementations, the scrolling of images may slow from a last scroll velocity to a stop over a predetermined period of time after the user lifts his or her finger to provide a slowing down effect to the scrolling.

If at 506 it is determined that the scrolling gesture is a swipe, then at 512, a velocity of the swipe is measured by the client computing device and the image scroll velocity determined in accordance with dataset size. The velocity may be determined by measuring swipe speed between an initial point and a terminal point of the swipe. At 514, images are scrolled at the image scroll velocity determined at 512. In some implementations, the scrolling of images may slow from the determined scroll velocity to a stop over a predetermined period of time after the user lifts his or her finger to provide a slowing down effect to the scrolling.

Thus, in accordance with the above, based on the velocity of a swipe of received within the touch-sensitive display, the present disclosure provides for both fine and rapid scrolling of slices through a user-initiate swipe gesture. Although the present disclosure has been described with reference to certain operational flows, other flows are possible. Also, while the present disclosure has been described with regard to patient image data, it is noted that scrolling of any type of image data may enabled.

In accordance with some implementations, a scrollbar maybe provided on the touch-sensitive display 114 as a user scrolls through the data set. In particular, in large data sets a user may lose track of where he or she is relative to the entire data set. Accordingly, an indicator, such as a rectangle, arrow or other, may be provided that appears on a portion of the touch-sensitive display 114 while a user is swiping to provide an indication of the relative position of the currently displayed slice with respect to the data set of slices. When the swiping gesture ends, the indicator may remain visible for a short period of time and then fade away. In some implementations, a user may be able to select the indicator to move it up or down to quickly jump to a portion of the data set.

### Example Remote Access Environment Implementation

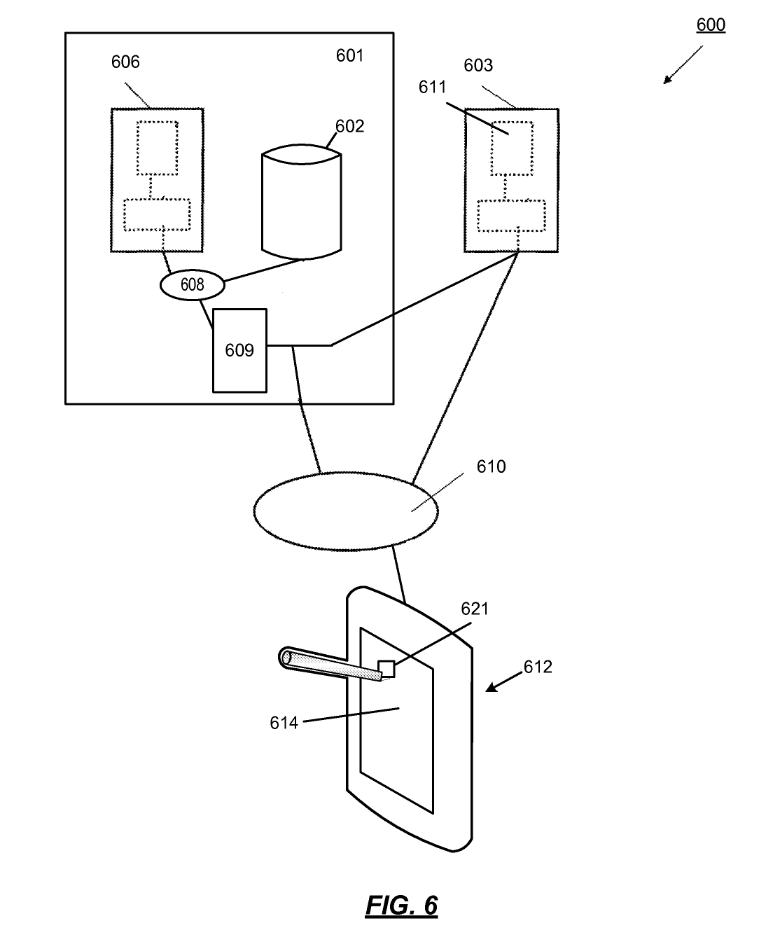

With the above overview as an introduction, reference is now made to FIG. 6 where there is illustrated an environment 600 for patient image data viewing, collaboration and transfer via a computer network. An imaging server computer 609 may be provided at a facility 601 (e.g., a hospital or other care facility) within an existing network as part of a medical imaging application to provide a mechanism to access data files, such as patient image files (studies) resident within a, e.g., a Picture Archiving and Communication Systems (PACS) database 602. Using PACS technology, a data file stored in the PACS database 602 may be retrieved and transferred to, for example, a diagnostic workstation 606 using a Digital Imaging and Communications in Medicine (DICOM) communications protocol where it is processed for viewing by a medical practitioner. The diagnostic workstation 606 may be connected to the PACS database 602, for example, via a Local Area Network (LAN) 608 such as an internal hospital network or remotely via, for example, a Wide Area Network (WAN) 610 or the Internet. Metadata may be accessed from the PACS database 602 using a DICOM query protocol, and using a DICOM communications protocol on the LAN 608, information may be shared. The server computer 609 may comprise a RESOLUTIONMD server available from Calgary Scientific, Inc., of Calgary, Alberta, Canada. The server computer 609 may be one or more servers that provide other functionalities within the facility 601.

A remote access server 603 is connected, for example, via the computer network 610 or the Local Area Network (LAN) 608 to the facility 601 and one or more client computing devices 612. The remote access server 603 includes a server remote access program 611 that is used to connect various client computing devices (described below) to applications, such as the medical imaging application provided by the server computer 609. The server remote access program 611 provides connection marshalling and application process management across the environment 600. The server remote access program 611 may field connections from remote client computing devices and broker the ongoing communication session between the client computing devices and the medical imaging application. For example, the remote access program 611 may be part of the PUREWEB architecture available from Calgary Scientific, Inc., Calgary, Alberta, Canada, and which includes collaboration functionality.

The client computing device 612 may be table device or mobile handset, such as, for example, an IPAD, an IPHONE or an ANDROID-based device connected via a computer network 610 such as, for example, the Internet, to a remote access server 603. It is noted that the connections to the communication network 610 may be any type of connection, for example, Wi-Fi (IEEE 802.11x), WiMax (IEEE 802.16), Ethernet, 3G, 4G, etc.

A client remote access program 621 may be designed for providing user interaction for displaying data and/or imagery in a human comprehensible fashion and for determining user input data in dependence upon received user instructions for interacting with the application program using, for example, a graphical display with touch-sensitive display 114 of the client computing device 612. An example client computing device 612 is detailed with reference to FIG. 1.

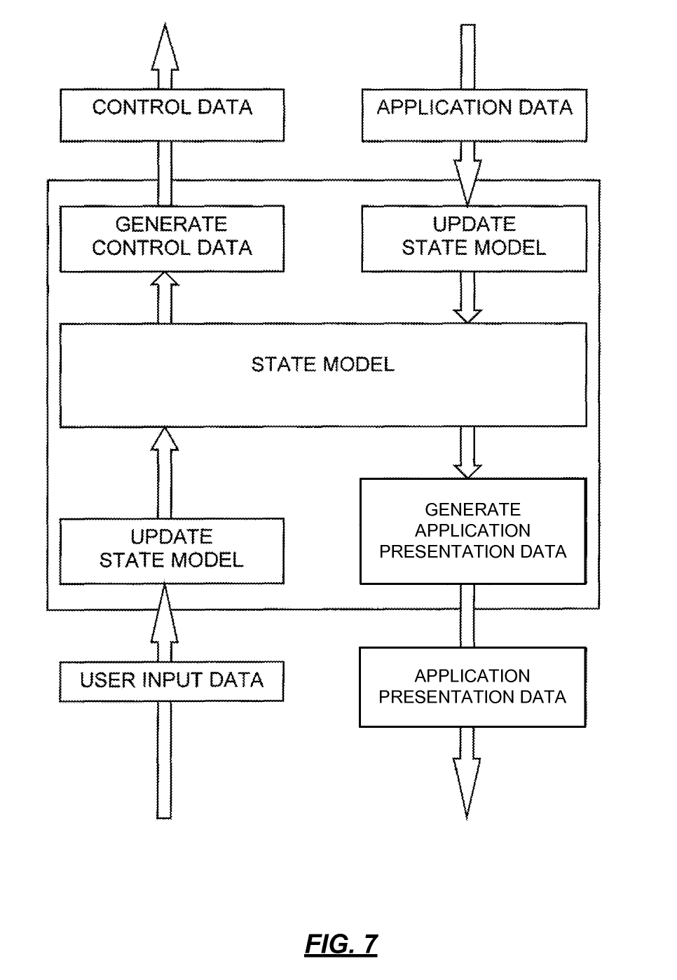

The operation of a server remote access program 611 with the client remote access program 621 can be performed in cooperation with a state model, as illustrated in FIG. 7 that contains the application state. When executed, the client remote access program 621 updates the state model in accordance with user input data received from a user interface program or imagery currently being displayed by the client computing device 612. The user input data may be determined as a result of a gesture, such as a swipe of the touch-sensitive display 114 and maintained within the state model. The remote access program 621 may provide the updated application state within the state model to the server remote access program 611 running on the remote access server 603. The server remote access program 611 may interpret the updated application state and make a request to the server 609 for additional screen or application data. The server remote access program 611 also updates the state model in accordance with the screen or application data, generates presentation data in accordance with the updated state model, and provides the same to the client remote access program 621 on the client computing device 612 for display. In the environment of the present disclosure, the state model may contain other information, such as a current slice being viewed by a user.

To provide scrolling at the client computing device 612, the determined swipe velocity may be populated into the state model as part of the application state and communicated by the client remote access program 621 to the server remote access program 611. Based on the information contained in the state model, the server remote access program 611 may make a request to the server 609 at the facility 601 hosting the patient image data to provide slices based on, e.g., one of the relationships and methods defined in FIGS. 2-5. As such the slices may be provided by the server 609 at a rate determined in accordance with the measured velocity of the swipe. For example, for relatively slower swipes, a slow scroll velocity is determined, whereas for relatively faster swipes, a faster scroll velocity is determined up to a maximum velocity. The slices would be communicated by the server remote access program 611 to the client remote access program 621 for display at the client computing device 612.

Numerous other general purpose or special purpose computing system environments or configurations may be used. Examples of well known computing systems, environments, and/or configurations that may be suitable for use include, but are not limited to, personal computers, server computers, handheld or laptop devices, multiprocessor systems, microprocessor-based systems, network personal computers (PCs), minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

It should be understood that the various techniques described herein may be implemented in connection with hardware or software or, where appropriate, with a combination of both. Thus, the methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computer, the machine becomes an apparatus for practicing the presently disclosed subject matter. In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an application programming interface (API), reusable controls, or the like. Such programs may be implemented in a high level procedural or object-oriented programming language to communicate with a computer system. However, the program(s) can be implemented in assembly or machine language, if desired. In any case, the language may be a compiled or interpreted language and it may be combined with hardware implementations.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A method of adaptive scrolling of images within a set of images, comprising:
defining a relationship of gesture velocity to an image scroll velocity;
displaying, in a display, an image from within the set of images;
receiving a user-initiated gesture;
determining a velocity of the user-initiated gesture; and
correlating the velocity of the user-initiated gesture to the image scroll velocity using the relationship to scroll the images on the display.

2. The method of claim 1, the display comprising a touch-sensitive display, the method further comprising:
determining that the gesture is a swipe on the touch-sensitive display; and
determining a swipe velocity to determine an image scroll velocity.

3. The method of claim 1, the display comprising a touch-sensitive display, the method further comprising:
determining that the gesture is a pan gesture on the touch-sensitive display; and
updating a pan gesture velocity and image scroll velocity over a duration of the pan gesture.

4. The method of claim 1, further comprising applying an adjustment to the relationship based on a size of the display.

5. The method of claim 4, wherein the adjustment is a multiplier.

6. The method of claim 1, wherein the image scroll velocity is relatively slower for slower gesture velocities and wherein the image scroll velocity is relatively faster for faster gesture velocities.

7. The method of claim 6, wherein a constant minimum scroll velocity is predetermined for a first range of the relatively slower gesture velocities and wherein a constant maximum swipe velocity is predetermined for a second range of the relatively faster gesture velocities.

8. The method of claim 7, wherein the scroll velocity is variable in accordance with gesture velocity between the first range and the second range.

9. The method of claim 1 wherein the gesture is received from a human interface device.

10. The method of claim 9, wherein the gesture is selected from the group consisting of mouse moments, touchpad inputs, game controller movements, and trackball movements.

11. A computing device for viewing a set of images on a display thereof, comprising:
a memory that stores one or more modules; and
a processor that executes the one or more modules to:
define a relationship of gesture velocity to an image scroll velocity;
display an image from within the set of images on the display;
receive a user-initiated scrolling gesture;
determine a velocity of the user-initiated gesture; and
correlate the velocity of the user-initiated gesture to the image scroll velocity using the relationship to scroll the images on the display.

12. The computing device of claim 11, wherein the processor further executes the one or more modules to:
determine that the image gesture is a swipe on a touch-sensitive display; and
determine a swipe velocity to determine an image scroll velocity.

13. The computing device of claim 11, wherein the processor further executes the one or more modules to:
determine that the image gesture is a pan gesture on a touch-sensitive display; and
update a pan gesture velocity and image scroll velocity over a duration of the pan gesture.

14. The computing device of claim 11, wherein the processor further executes the one or more modules to apply an adjustment to the relationship based on a size of the display.

15. The computing device of claim 11, wherein the image scroll velocity is relatively slower for slower image gesture velocities and wherein the image scroll velocity is relatively faster for faster image gesture velocities.

16. The computing device of claim 15, wherein a constant minimum scroll velocity is predetermined for a first range of the relatively slower image gesture velocities and wherein a constant maximum swipe velocity is predetermined for a second range of the relatively faster image gesture velocities.

17. The computing device of claim 16, wherein the image scroll velocity is variable in accordance with image gesture velocity between the first range and the second range.

18. The computing device of claim 11, wherein the gesture is received from a human interface device.

19. The computing device of claim 18, wherein the gesture is selected from the group consisting of mouse moments, touchpad inputs, game controller movements, and trackball movements.

20. A method of adaptive scrolling a document displayed on a display of a computing device, comprising:
defining a relationship of image gesture velocity to a document scroll velocity, the relationship being based on one of a screen size of the display and a document size;
displaying the document on the display;
receiving a user-initiated gesture from a human interface device of the computing device;
determining a velocity of the user-initiated gesture; and
correlating the velocity of the user-initiated gesture to the document scroll velocity using the relationship to scroll the images on the display.
